(19) United States
(12) Patent Application Publication
(10) Pub. No.: US 2020/0269329 A1
(43) Pub. Date: Aug. 27, 2020

(54) CUTTER HOLDER STRUCTURE

(71) Applicant: HSIN-TIEN CHANG, TAICHUNG CITY (TW)

(72) Inventor: HSIN-TIEN CHANG, TAICHUNG CITY (TW)

(21) Appl. No.: 16/674,170

(22) Filed: Nov. 5, 2019

(30) Foreign Application Priority Data
Feb. 27, 2019 (TW) 108106708
May 17, 2019 (TW) 108116994

(51) Int. Cl. B23B 31/107; B23B 27/16; B23B 31/11

(52) U.S. Cl. CPC B23B 31/1075; B23B 31/11; B23B 27/16

(57) ABSTRACT

A cutter holder structure comprises a cutter arbor and a connecting shaft having a tapered section at one end thereof. One end of the tapered section is formed with a first inner screw hole, and another end of the tapered section is formed with a second inner screw hole. The connecting shaft further has a horizontal positioning hole that penetrates through the connecting shaft. Two ends of the positioning hole are formed with cylindrical holes. A reduced hole is defined between the cylindrical holes. A nut has a third inner screw hole at one end and an axial hole at another end. The nut further has a horizontal countersink hole and a horizontal fourth inner screw hole. An eccentric distance is defined between a center of the countersink hole and a center of the fourth inner screw hole. A screw is inserted through the countersink hole and locked into the fourth inner screw hole.

### FIELD OF THE INVENTION

The present invention relates to a clamping structure of a cutter holder, and more particularly to a cutter holder structure that has a high locking rigidity and can be applicable to different cutters with the same cutter arbor.

### BACKGROUND OF THE INVENTION

Generally, a cutter holder has a collet. As shown in FIG. 10 and FIG. 11, a straight shank cutter holder with an ER collet is mainly used for a power cutter of a machine tool or mounted to the spindle of a machine tool. The cutter holder (8) mainly comprises a cutter arbor (81). The front end of the cutter arbor (81) is provided with a clamping structure. The clamping structure comprises an inner tapered hole (811) at the front end of the cutter arbor (81) to accommodate a collet (82) therein. The collet (82) is configured to receive a straight shank cutter (6), such as a milling cutter, a drill bit, a tapping cutter, etc., and the cutter (6) is locked by a nut (83). The nut (83) forces the collet (82) to retract inward and clamp the cutter (6), thereby quickly mounting and dismounting the cutter (6). Referring to FIG. 11, an ER16 collet is taken as an example, which can clamp the cutter (6) with a shank having a diameter of 1-10 mm. Each type of collet (82) is retracted in a limited range for clamping the cutter, so the size of the shank of the cutter is subject to the collet. The maximum size for this collet to clamp a cutter is 10 mm, so the application range of a single collet (82) is limited. For a more complex and diverse machining environment, users have to purchase more collets (82) of different sizes for fast-changing and diverse machining.

As to the conventional cutter holder (8) having the collet (82), the clamping structure designed at its front end includes the collet (82) as a main clamping mechanism and the cutter arbor (81) in cooperation with the nut (83) to lock the cutter (6). However, each type of collet (82) is retracted in a limited range for clamping the cutter. Users have to purchase more collets (82) of different sizes, which increases the machining cost. Accordingly, the inventor of the present invention has devoted himself based on his many years of practical experiences to solve these problems.

### SUMMARY OF THE INVENTION

The primary object of the present invention is to provide a cutter holder structure, comprising a cutter arbor, a connecting shaft, and a nut. The cutter arbor has a through hole therein. A front end of the through hole is formed with an inner tapered hole. One end of the cutter arbor is provided with an external thread. The connecting shaft has a tapered section at one end thereof. The tapered section corresponds to the inner tapered hole of the cutter arbor. One end of the tapered section is formed with a first inner screw hole for locking a set screw. Another end of the tapered section is formed with a second inner screw hole. The connecting shaft further has a horizontal positioning hole that penetrates through the connecting shaft and is adjacent to the tapered section. Two ends of the positioning hole are formed with cylindrical holes. A reduced hole is defined between the cylindrical holes at the two ends of the positioning hole. Two ends of the reduced hole are connected to the cylindrical holes. The reduced hole is in a circular arc shape. The reduced hole between the two cylindrical holes may be a positioning cylindrical hole. The nut has a third inner screw hole at one end and an axial hole at another end. The nut further has a horizontal countersink hole and a horizontal fourth inner screw hole. An eccentric distance is defined between a center of the countersink hole and a center of the fourth inner screw hole. The eccentric distance is about 0.05-0.1 mm. A screw is inserted through the countersink hole and locked into the fourth inner screw hole.

According to the cutter holder structure of the present invention, if the cutter arbor is a cutter arbor used for connecting an ER16 collet (10 mm), the maximum size of a cutter to be connected to the connecting shaft is 16 mm, so that the application range of the size of the cutter is thus increased by 60%. Alternatively, between the two cylindrical holes of the positioning hole is a positioning cylindrical hole that is in tight contact with the screw to improve the rigidity. The maximum size of a cutter to be connected to the connecting shaft may be 30 mm, and the application range of the size of the cutter is therefore increased by 3 times. In addition, the length of the connecting shaft may be changed, which can increase the application range of the machining and make the machining more flexible.

### BRIEF DESCRIPTION OF THE DRAWINGS

FIG. 1 is an exploded view of the present invention;

FIG. 2 is an assembled cross-sectional view of the present invention;

FIG. 3 is a schematic view of an exemplary embodiment of a different nut of the present invention;

FIG. 4 is a cross-sectional view of the present invention, showing the reduced hole in a circular arc shape of the connecting shaft;

FIG. 5 is a schematic view of an exemplary embodiment of different cutters coupled to the present invention;

FIG. 6 is a schematic view of an exemplary embodiment of the connecting shaft of the present invention;

FIG. 7 is an exploded sectional view of the present invention, showing that the reduced hole of the connecting shaft is a cylindrical hole;

FIG. 8 is an assembled sectional view of the present invention, showing that the reduced hole of the connecting shaft is a cylindrical hole;

FIG. 9 is a schematic view of the present invention in cooperation with various nuts and cutters having different cutting functions;

FIG. 10 is an exploded sectional view of a conventional straight shank cutter holder with an ER collet; and

FIG. 11 is an assembled sectional view of the conventional straight shank cutter holder with the ER collet.

### DETAILED DESCRIPTION OF THE PREFERRED EMBODIMENTS

Embodiments of the present invention will now be described, by way of example only, with reference to the accompanying drawings.

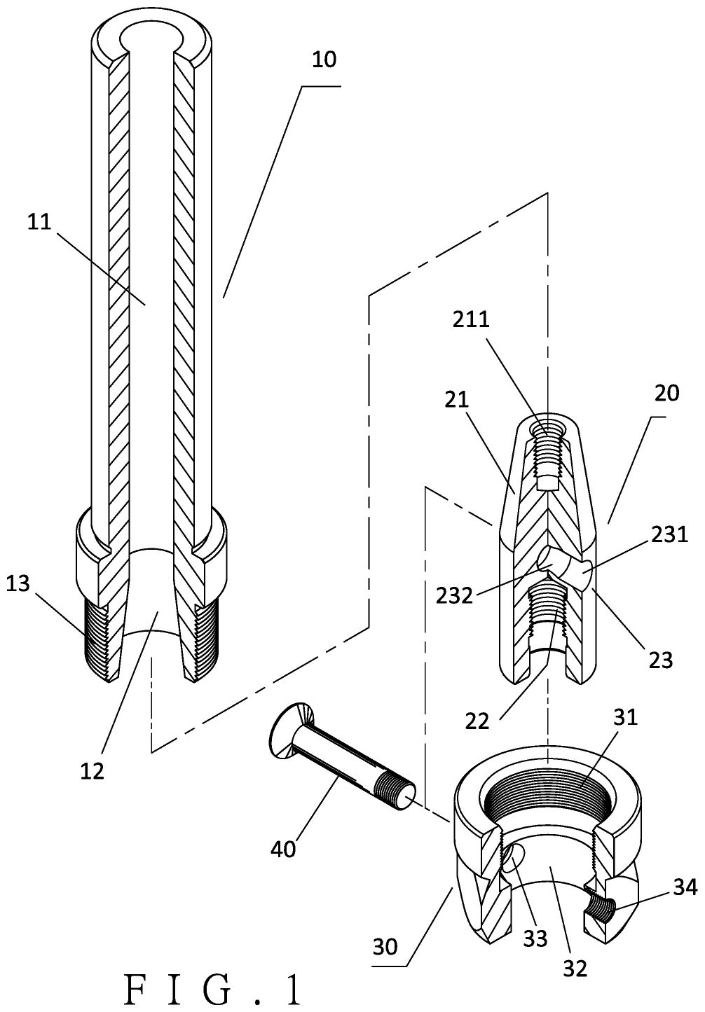

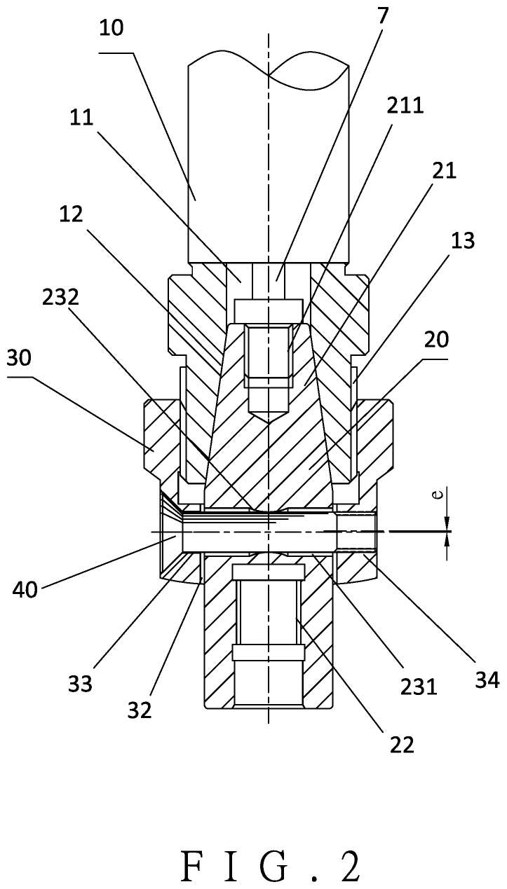

Referring to FIG. 1 and FIG. 2, the cutter holder structure of the present invention comprises a cutter arbor (10), a connecting shaft (20) and a nut (30). The cutter arbor (10), such as a commercially available straight or tapered cutter arbor, has a through hole (11) therein. The front end of the through hole (11) is formed with an inner tapered hole (12). One end of the cutter arbor (10) is provided with an external thread (13).

The connecting shaft (20) has a tapered section (21) at one end thereof. The tapered section (21) corresponds to the inner tapered hole (12) of the cutter arbor (10). One end of the tapered section (21) is formed with a first inner screw hole (211) for locking a set screw (7). Another end of the tapered section (21) is formed with a second inner screw hole (211) for locking a cutter (50), such as a milling cutter, a drill bit, etc. (as shown in FIG. 5). The connecting shaft (20) has a horizontal positioning hole (23) that penetrates through the connecting shaft (20) and is adjacent to the tapered section (21). Two ends of the positioning hole (23) are formed with cylindrical holes (231). The diameter of the cylindrical hole (231) is greater than the shaft diameter of a screw (40) by about 20%, so that the screw (40) has a greater movable space when it is accommodated in the cylindrical hole (231). A reduced hole (232) is defined between the cylindrical holes (231) at the two ends of the positioning hole (23). The diameter of the middle portion of the reduced hole (232) is the smallest. The diameter of the reduced hole (232) is greater than the shaft diameter of the screw (40) by about 0.1 mm or less. The diameter of two ends of the reduced hole (232) is the largest. The two ends of the reduced hole (232) are connected to the cylindrical holes (231). The reduced hole (232) is in a circular arc shape.

The nut (30) has a third inner screw hole (31) at one end and an axial hole (32) at another end. The nut (30) further has a horizontal countersink hole (33) and a horizontal fourth inner screw hole (34). An eccentric distance (e) is defined between the center of the countersink hole (33) and the center of the fourth inner screw hole (34). The eccentric distance (e) is about 0.05-0.1 mm according to this embodiment. The fourth inner screw hole (34) is higher than the countersink hole (33).

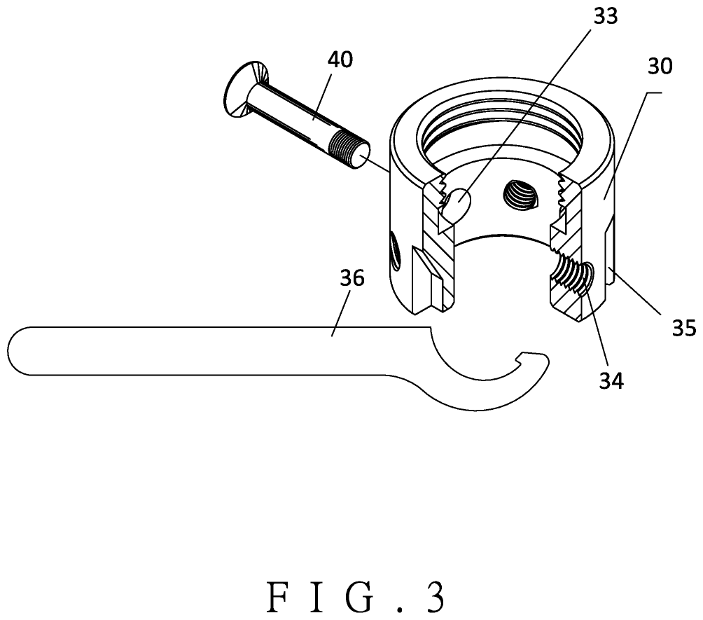

Referring to FIG. 1, the nut (30) of the present invention may be a hexagonal nut, and it may be in different shapes. As shown in FIG. 3, the outer circumference of the nut (30) is formed with a plurality of grooves (35), and the nut (30) is tightened or loosened by a wrench (36). In addition, the countersink hole (33) and the fourth inner screw hole (34) of the nut (30) may be more than one set and annularly arranged on the outer circumference of the nut (30).

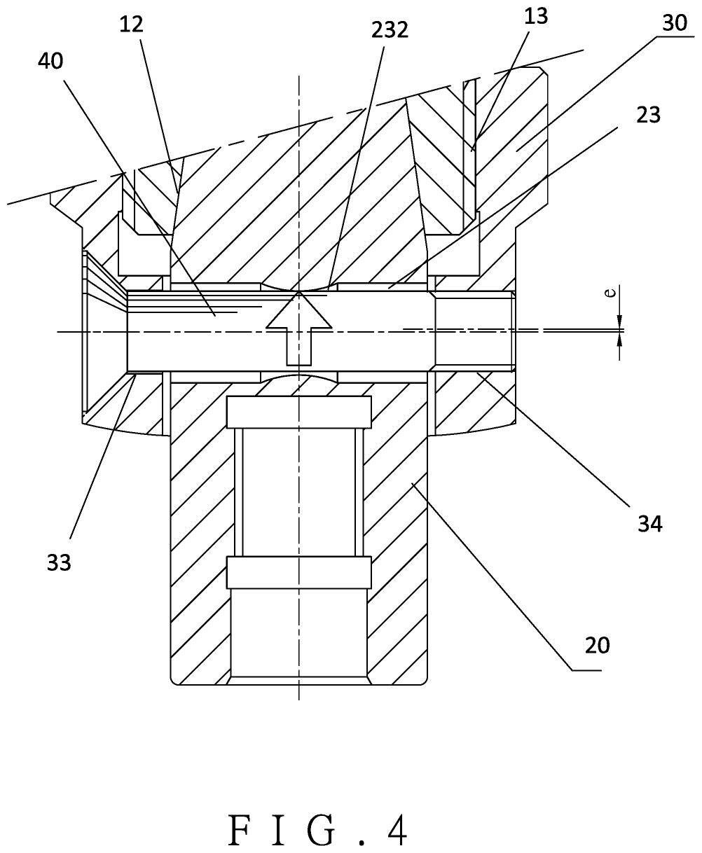

Referring to FIG. 2 and FIG. 4, the connecting shaft (20) of the present invention is inserted in the nut (30), and the positioning hole (23) is aligned with the countersink hole (33) and the fourth inner screw hole (34) of the nut (30), and the screw (40) is inserted in the holes and locked. Because an eccentric distance (e) is defined between the center of the countersink hole (33) and the center of the fourth inner screw hole (34), the eccentric distance (e) is about 0.05-0.1 mm according to this embodiment, that is, the fourth inner screw hole (34) is higher than the countersink hole (33). When the screw (40) is gradually locked into the fourth inner screw hole (34) that is higher than the countersink hole (33), the screw (40) is deflected upward (slightly deflected in a clockwise direction) with the fourth inner screw hole (34) as a fulcrum, and the screw (40) gradually pushes up the reduced hole (232) of the connecting shaft (20). The reduced hole (232) is in a circular arc shape, so the screw (40) is in contact with the reduced hole (232) with a single point to push the connecting shaft (20) up. The nut (30) is locked to the external thread (13) of the cutter arbor (10) and pushes up the connecting shaft (20) through the inner tapered hole (12) of the cutter arbor (10) to connect with the cutter arbor (10). Accordingly, the connecting shaft (20) is pushed by the screw (40) and is pushed upward by the nut (30) to achieve a double locking effect.

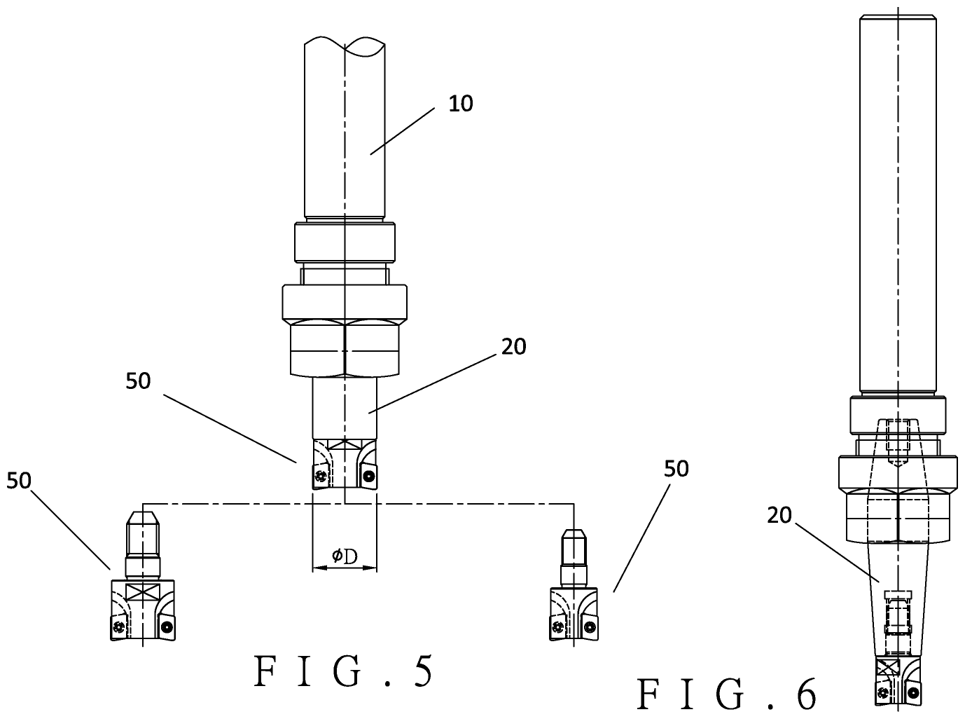

As shown in FIG. 5, the present invention changes the structure of the cutter arbor. The connecting shaft (20) can be connected with cutters (50) of different sizes. According to this embodiment, if the cutter arbor (10) is a cutter arbor used for connecting an ER16 collet, the maximum sizeψD of a cutter to be connected to the cutter arbor (10) is 16 mm, so that the application range of the sizeψD of the cutter is thus increased by 60%. In addition, as shown in FIG. 6, the length of the connecting shaft (20) may be changed, so as to increase the application range for machining.

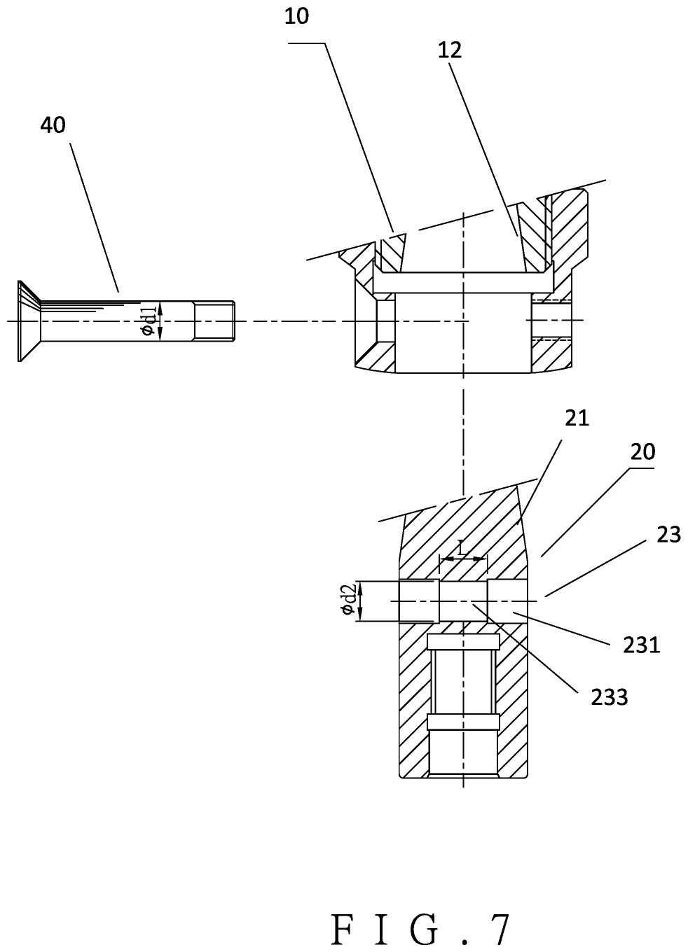

According to the aforesaid, if the cutter arbor (10) is a cutter arbor used for connecting an ER16 collet, the maximum sizeψD of a cutter to be connected to the cutter arbor (10) is 16mm, which is based on the locking rigidity of the connecting shaft (20) and the nut (30). If it is necessary to increase the maximum sizeψD of the cutter, the locking rigidity of the connecting shaft (20) and the nut (30) can be increased. Referring to FIG. 7, the connecting shaft (20) has the horizontal positioning hole (23) adjacent to the tapered section (21). The two ends of the positioning hole (23) are formed with the cylindrical holes (231) having a diameter greater than the diameterψ(d1) of the screw (40). Between the cylindrical holes (231) is a positioning cylindrical hole (233) having a small diameterψ(d2), which is different from the aforementioned reduced hole (232). The diameterψ(d2) of the positioning cylindrical hole (233) is greater than the diameterψ(d1) of the screw (40). The tolerance of the diameter is between 0 and 0.05 mm, so that the screw (40) is in tight contact with the positioning cylindrical hole (233). The positioning cylindrical hole (233) and the screw (40) will be tightly fitted.

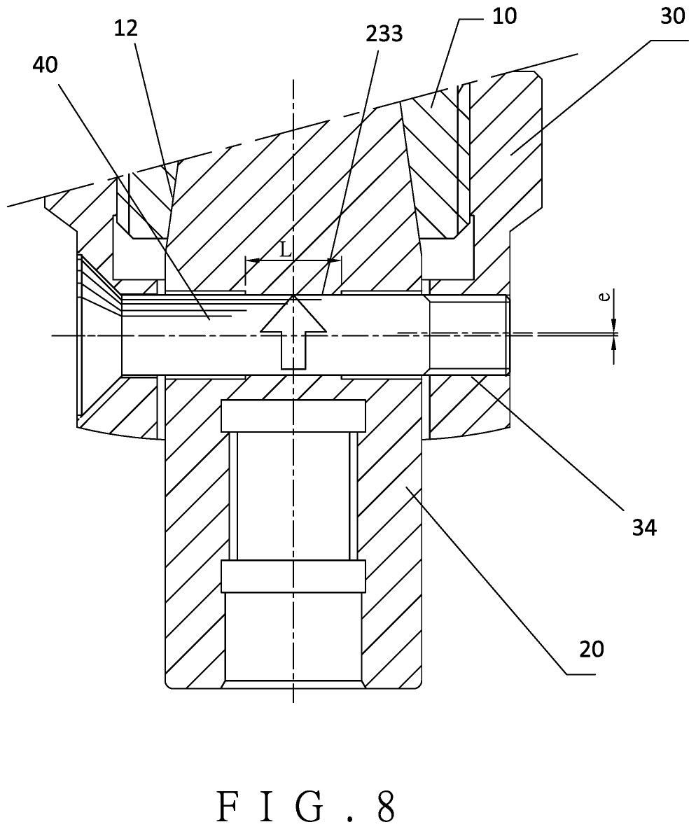

Referring to FIG. 8, when the screw (40) is screwed into the fourth inner screw hole (34) that is eccentrically arranged, the screw (40) will push the connecting shaft (20) up at the positioning cylindrical hole (233), so that he connecting shaft (20) is more closely fitted with the inner tapered hole (12) of the cutter arbor (10), and the positioning cylindrical hole (233) has a larger contact area with the screw (40). As shown in FIG. 7, the length (L) of the positioning cylindrical hole (233) is the contact length with the screw (40). The longer the contact length (L), the tighter fit. Therefore, the locking rigidity of the connecting shaft (20) and the inner tapered hole (12) of the cutter arbor (10) is increased, which will relatively increase the cutting rigidity of the cutter, thereby increasing the maximum sizeψD of the cutter. According to the actual cutting experiment, if the cutter arbor (10) is a cutter arbor used for connecting an ER16 collet (10 mm), the maximum sizeψD of a cutter to be connected to the cutter arbor (10) may be 30 mm, and the application range of the size ψD of the cutter is therefore increased by 3 times.

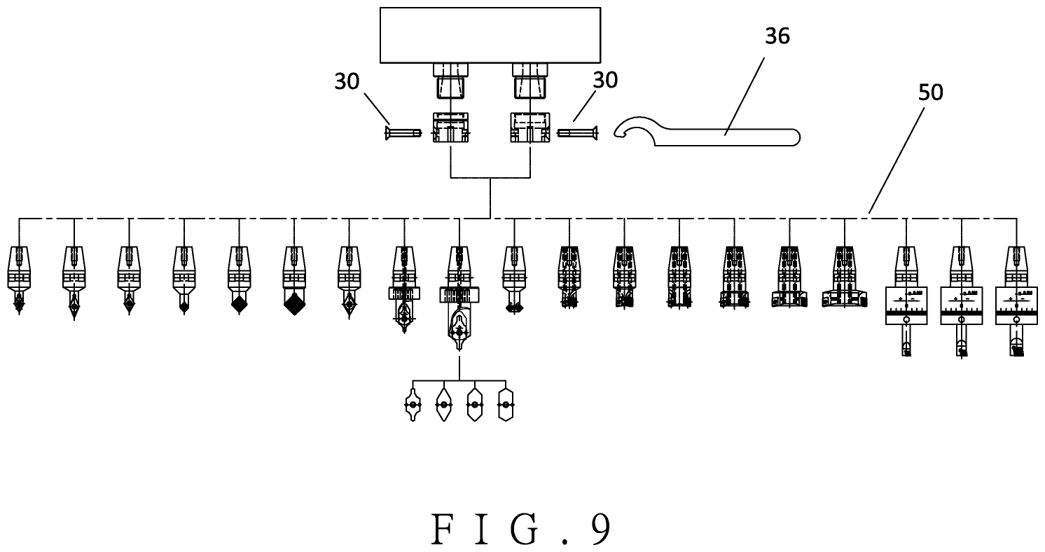

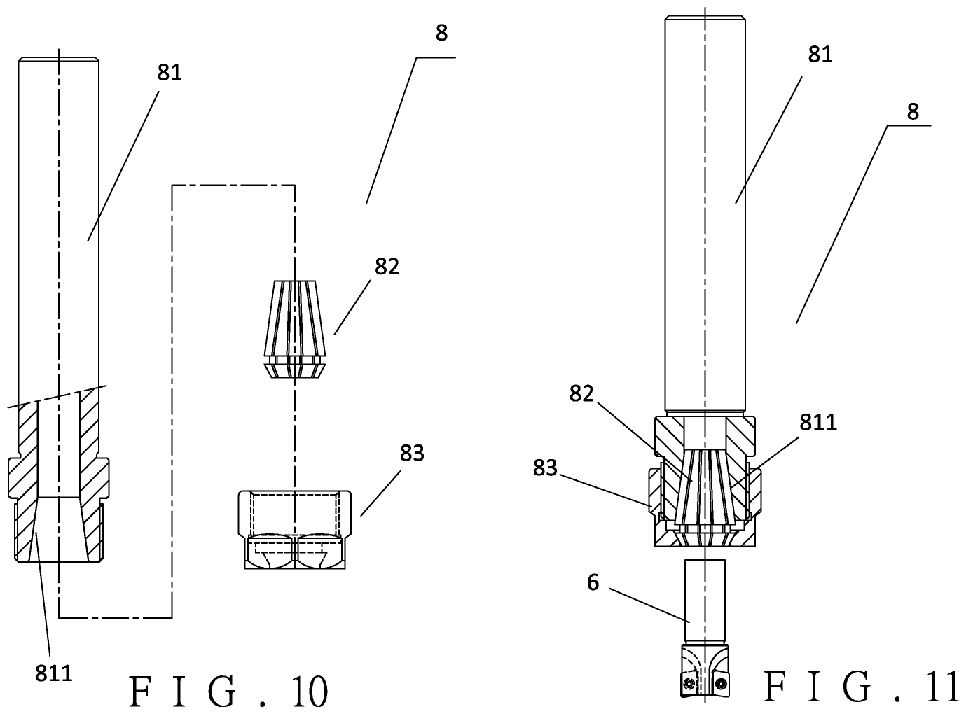

Referring to FIG. 9, the present invention can be combined with various nuts (30) to lock or unlock cutters (50) with different cutting functions through a wrench (36), so it can be widely used and is very practical.

In summary, the cutter holder structure of the present invention changes the traditional technique using the collet to clamp the cutter, by providing a screw to connect the connecting shaft and the of the nut. The locking rigidity is better, and the connecting shaft is used for locking cutters of different sizes. The application range of the cutters increases 1.6-3 times.

The present invention can improve the cutting range of the cutter, meeting the requirements of cutting conditions and environment for various workpieces. The present invention is practical and progressive.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A cutter holder structure, comprising:
a cutter arbor, having a through hole therein, one end of the through hole being formed with an inner tapered hole, one end of the cutter arbor being provided with an external thread;
a connecting shaft, having a tapered section at one end thereof, the tapered section corresponding to the inner tapered hole of the cutter arbor, one end of the tapered section being formed with a first inner screw hole for locking a set screw, another end of the tapered section being formed with a second inner screw hole, the connecting shaft further having a horizontal positioning hole that penetrates through the connecting shaft and is adjacent to the tapered section, two ends of the positioning hole being formed with cylindrical holes, a reduced hole being defined between the cylindrical holes at the two ends of the positioning hole, two ends of the reduced hole being connected to the cylindrical holes;
a nut, having a third inner screw hole at one end and an axial hole at another end, the nut further having a horizontal countersink hole and a horizontal fourth inner screw hole, an eccentric distance being defined between a center of the countersink hole and a center of the fourth inner screw hole;
a screw, inserted through the countersink hole and locked into the fourth inner screw hole.

2. The cutter holder structure as claimed in claim 1, wherein the cylindrical holes at the two ends of the positioning hole of the connecting shaft each have a diameter greater than a shaft diameter of a screw by about 20%.

3. The cutter holder structure as claimed in claim 1, wherein a middle portion of the reduced hole having a diameter greater than a shaft diameter of the screw by about 0.1 mm or less.

4. The cutter holder structure as claimed in claim 1, wherein the reduced hole is a positioning cylindrical hole.

5. The cutter holder structure as claimed in claim 1, wherein the reduced hole is in a circular arc shape.

6. The cutter holder structure as claimed in claim 1, wherein the eccentric distance between the center of the countersink hole and the center of the fourth inner screw hole is about 0.05-0.1 mm, and the fourth inner screw hole is higher than the countersink hole.
